(19) United States
(12) Patent Application Publication
(10) Pub. No.: US 2026/0129422 A1
(43) Pub. Date: May 7, 2026

(54) DYNAMIC TRANSACTIONS USING AN OPERATOR MARKETPLACE

(71) Applicant: Cisco Technology, Inc., San Jose, CA (US)

(72) Inventors: Tomonobu Okada, Tokyo (JP); Snezana Mitrovic, Leefdaal (BE); Steven Loos, Ternat (BE); Alwin Xavier Pulikkal Xavier, Tienen (BE); Vinay Saini, Bangalore (IN)

(21) Appl. No.: 18/935,189

(22) Filed: Nov. 1, 2024

(51) Int. Cl. H04W 8/08

(52) U.S. Cl. CPC H04W 8/08

(57) ABSTRACT

In one aspect, a method includes receiving one or more requests from one or more operators to initiate an association with an operator marketplace, authenticating the one or more requests, and registering the one or more operators associated with the authenticated one or more requests with the operator marketplace. The method may also include monitoring the one or more operators with a network data analytics function (NWDAF), and receiving, from the one or more operators, resources provided by the one or more operators. The method may also include broadcasting the resources to the one or more operators and receiving a subscription request from a first operator. The subscription request may include a request to activate a roaming agreement with a second operator. The method may further include activating the roaming agreement between the first operator and the second operator for a duration of time.

### TECHNICAL FIELD

The present technology pertains to network roaming, and, more specifically, to a roaming marketplace to facilitate an exchange of resources between network operators.

### BACKGROUND

Cell network roaming is a critical feature in modern telecommunications that allows mobile devices to maintain connectivity across different cellular networks as users move beyond the coverage area of their home network. This functionality is essential for ensuring uninterrupted voice, data, and messaging services, particularly when users travel internationally or across regions served by different network operators. Roaming involves complex processes, including the authentication of the roaming device, negotiation of service agreements between the home and visited networks, and the seamless handoff of ongoing communications sessions. As mobile technology evolves, challenges such as optimizing data rates, managing security, and reducing latency during roaming transitions continue to drive innovations in network protocols and infrastructure. Additionally, there is no universal solution for facilitating an exchange of resources between networks and processing the transition of a mobile device from one network to another.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates a schematic diagram of an example of an environment including home and visited wireless communication networks according to some aspects of the present technology.

FIG. 2 illustrates an example of an operator marketplace and associated operators according to some aspects of the present technology.

FIG. 3A illustrates an example process for deregistering a user device from an operator according to some aspects of the present technology.

FIG. 3B illustrates an example process for registering the user device with a roaming operator according to some aspects of the present technology.

FIGS. 4A-4C illustrate an example process for facilitating an operator marketplace between one or more operators according to some aspects of the present technology.

FIG. 5 illustrates an example flowchart for facilitating an operator marketplace between one or more operators according to some aspects of the present technology.

FIG. 6 shows an example of a system for implementing certain aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

### OVERVIEW

In one aspect, a computer-implemented method for facilitating a marketplace for roaming agreements, includes receiving one or more requests from one or more operators to initiate an association with an operator marketplace, authenticating the one or more requests, and registering the one or more operators associated with the authenticated one or more requests with the operator marketplace. The method may also include monitoring the one or more operators with a network data analytics function (NWDAF), and receiving, from the one or more operators, resources provided by the one or more operators. The method may also include broadcasting the resources to the one or more operators and receiving a subscription request from a first operator. The subscription request may include a request to activate a roaming agreement with a second operator. The subscription request may include one or more required resources, and if the resources provided by the second operator correspond to the one or more required resources of the first operator, the method may further include activating the roaming agreement between the first operator and the second operator for a duration of time.

In some aspects, the method may also include where when the duration of time ends, the roaming agreement expires and associated user devices serviced by the second operator by the roaming agreement resume service from the first operator.

In some aspects, the method may also include where the one or more operators are associated with an instance of a cellular system hub (CSH) and the respective CSH for the one or more operators facilitates the activation and deactivation of service for associated user devices.

In some aspects, the method may also include where when the roaming agreement is activated, a CSH associated with the first operator transmits a request to de-register a first user device from a communication network associated with the first operator.

In some aspects, the method may also include where when the roaming agreement is activated, a CSH associated with the second operator transmits a request to register a first user device from a communication network associated with the second operator.

In some aspects, the method may also include transmitting a message to a unified data management (UDM) of the first network that includes at least the roaming agreement, an identification of the user device and the second operator.

In some aspects, the method may also include where the NWDAF determines, using analytics associated with the one or more operators, the one or more resources available from the one or more operators. Other technical features may be readily apparent to one skilled in the art from the following figures, descriptions, and claims.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for a method of facilitating the exchange of networking resources for mobile device roaming. When mobile subscribers leave the coverage of their provider, cellular connectivity depends on multiple factors, including, but not limited to, roaming agreements between operators. The agreements are typically made up front, with associated pricing and performance which provides limited flexibility to offer dynamic services to the end users. However, this gives no flexibility to govern the cost or performance. Hence, subscribers might end up with poor connection (e.g., a roaming partner might not have proper coverage in the area), while other providers are available with better coverage (but no formal agreement and consequently, often no service), or with a limited set of services (e.g., no attractive charging plans). Additionally, such static agreements do not allow for flexibility for operators to negotiate different roaming parameters (e.g., pricing, Quality of Service, type of radio access, etc.). There is a need for a mechanism that allows a given operator to sell/place its resources in a marketplace and allow operators to dynamically bid and consume those resources.

The solution described herein is a Cellular System/Operator Hub that acts as an active marketplace for Operators to transaction. The hub/marketplace may be referred to as a Cellular System Hub (CSH) and the functionality of the CSH may be exposed via network exposure function (NEF). Each operator (e.g., a cellular network operator, such as AT&T, Verizon, etc.) would have a CSH instance associated with the operator. Communication between the operators would occur at a central CSH marketplace (CSH Home). In some examples, there may exist regional marketplaces.

The CSH associated with each operator may advertise its parameters (e.g., pricing, speed, availability, etc.) to other CSH/operators via the CSH Home marketplace. In this manner, all CSH participating in the marketplace are aware of the parameters of other CSH instances. According to policies applicable to the CSH of a particular operator, an operator may determine a need to enter into a roaming agreement with a second operator. The need may be determined by a Network Data Analysis Function (NWDAF) configured to monitor analytics for the one or more operators associated with the CSH Home. As an example, Operator A and Operator B may dynamically negotiate based on the advertisements broadcasted by CSH Home and reach a roaming agreement for one or more user devices associated with the operators'network. The roaming agreement may also include a time period in which the roaming agreement is valid. CSH Home may also facilitate the registration and the de-registration of one or more user devices according to the roaming agreement.

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

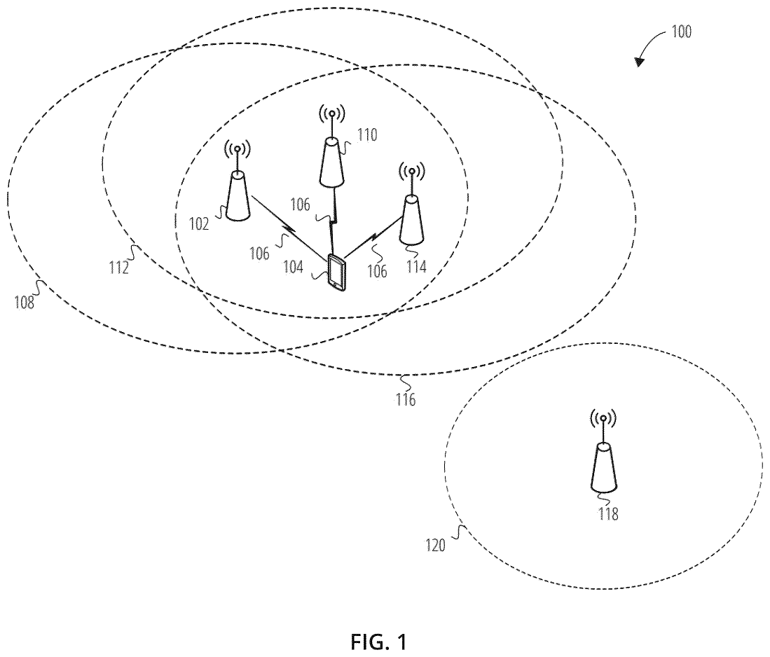

FIG. 1 shows a block diagram of an example a roaming scenario according to some aspects of the present disclosure. The roaming scenario 100 can include a radio access network (RAN) 118 for a home public land mobile network (HPLMN) and RANs for several visited public land mobile network (VPLMN), which are illustrated by RAN 102 for a VLPMN-A, RAN 110 for VLPMN-B, and RAN 114 for VLPMN-C. In FIG. 1, the user equipment (UE) 104 is out of the coverage area 120 of RAN 102 and the HPLMN, but the UE 104 is within the coverage area 108 of the VPLMN-A. Additionally, the UE 104 is within the coverage area 108 of the VPLMN-B, and the UE 104 is within the coverage area 116 of the VPLMN-C. Respective communication links 106 can connect the UE 104 to each of the RANs 102, 110, and 114. In the roaming scenario 100, the UE 104 is a subscriber to the HPLMN, and, when the UE 104 leaves the coverage area 120 of the HPLMN, roaming allows the UE 104 to continue to send and receive messages with by using one of the VPLMNs.

In wireless telecommunications, the term “roaming” can refer to a situation in which mobile devices (e.g., UE 104) are being used outside the range of its native network by connecting to another available cell network. Further, roaming can refer to a functionality in which a cellular customer uses a visited network to automatically make and receive voice calls, send and receive data, or access other services, including home data services, when travelling outside the geographical coverage area of the home network. For example, should a subscriber travel beyond their cell phone company's transmitter range, their cell phone would automatically hop onto another phone company's service, if available. The term “home network” refers to the network the subscriber is registered with, and “visited network” refers to the network a subscriber roams temporarily and is outside the bounds of the home network. The legal roaming business aspects negotiated between the roaming partners for billing of the services obtained are usually stipulated in roaming agreements 3GPP supports steering of roaming (SoR) in which a Home PLMNs uses a roaming partners list (RPL) to steer their roaming subscribers to preferred partner networks by means of updating the Operator Controlled PLMN Selector list via signaling. Using the RPL, an operator can direct a UE 104 to latch on to preferred roaming partner via SoR based on roaming agreement/costs.

In FIG. 1, the UE 104 can latch onto one of the roaming partners VPLMN-A, VPLMN-B, and VPLMN-C. The RPL can be used to ensure that the UE 104 latches onto the visited network with the most favorable roaming agreement/costs. But sometimes the UE 104 can require services/features that are only available from some of the visited networks. The systems and methods described herein overcome this limitation by augmenting the roaming steering process to provide network capability awareness.

Consider an example in which, the UE 104 enables an Access Traffic Steering, Switching and Splitting (ATSSS) feature while roaming, The ATSSS feature allows the diversion of some traffic over Non-3GPP access. Not all visited networks will support ATSSS. Thus, to ensure that the UE 104 latches on to a visited network that supports the desired network capability (i.e., ATSSS in this case), the UE 104 would need to be aware of which visited networks support the desired network capability. For example, it is possible that a given visited network supports both 3GPP/Non-3GPP access but does not support ATSSS, which depends on several enhancements in the core network (e.g., ATSSS-LL, MPTCP, MPTCP Proxy, etc.).

Currently, 3GPP lacks such information as part of RPL in the SoR and there is no way for UE 104 to selectively latch on the visited network where certain specific network capabilities are supported. Although access technology and slice is part of the SoR information which can be used by UE 104 to select a particular visited network based on the supported slice, in the RPL generated by SoR that is provided in 3GPP, the capabilities provided by the visited network are not accounted for, such that a UE 104. If, however, the capabilities provided by the visited network were accounted for (as is the case for certain systems and methods disclosed herein), then the RPL generated by SoR would enable the UE 104 to latch on to the preferred visited network that has the desired network capabilities.

The above example in which the desired network capability is ATSSS is non-limiting, and the desired network capability can be any existing network capability or any network capability that is developed in the future. For example, there are many such capabilities supported by 5GC (ATSSS, non-regulatory Location services or TSN) which may/may not be supported by a visited network. Therefore, bringing network capabilities level cognizance in the RPL is beneficial to enable UEs to select the most appropriate visited network that serves the UEs needs.

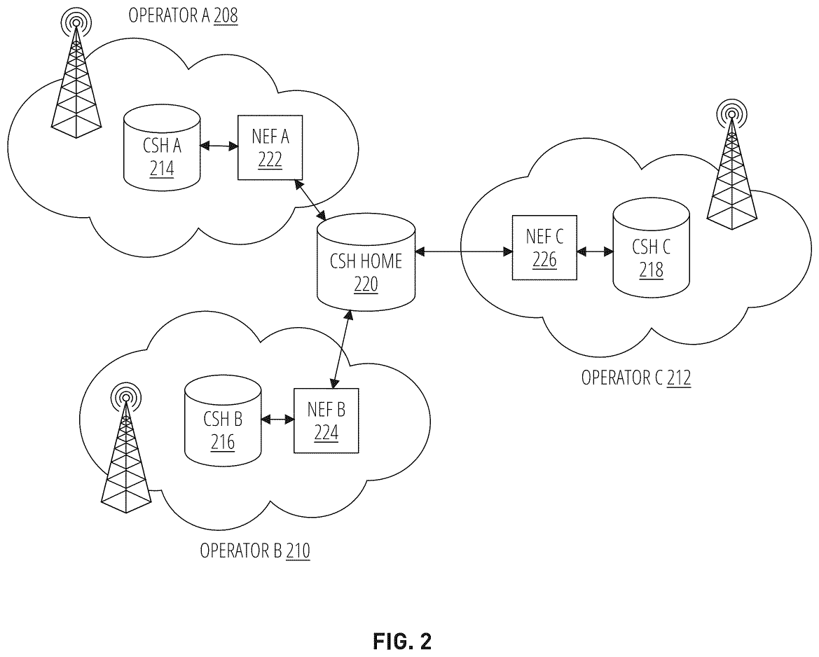

FIG. 2 illustrates an example of an operator marketplace and associated operators according to some aspects of the present technology. A user device may be associated with one particular operator (e.g., Verizon, AT&T, Vodafone, etc.). When a user device “roams” outside of a coverage area of the particular operator, the particular operator may have an agreement with a second operator to provide coverage for the user device on behalf of the particular operator. These roaming agreements ensure that the coverage of the user device will not be interrupted. In some examples, the second operator that “picks up” the user device may not be the optimal operator for the user device. For example, the second operator may not be equipped to provide proper bandwidth, speeds, coverage, any combination thereof, or the like. However, the particular operator may not have the ability to negotiate with another operator other than the second operator due to contractual obligations or other restraints.

Using Cellular System Hub (CSH) home 220 and the method described in FIG. 2 and throughout the specification, one or more operators may join a central roaming marketplace that facilitates the exchange of roaming resources between the one or more operators. CSH home 220 may be a central server configured to manage resource agreements between operators. In some examples, CSH home 220 may be hosted on a cloud server. In some examples, operators associated with CSH home 220 may also be associated with individual CSH servers and/or individual CSH instances. The individual CSH instances may be configured to communicate with CSH home 220 and advertise parameters (e.g., tariffs, available resources, needed resources, etc.) to CSH home 220. For example, CSH A 214 (associated with Operator A 208), CSH B 216 (associated with Operator B 210), and/or CSH C 218 (associated with operator C 212) may advertise parameters to CSH home 220. In some examples, the parameters may depend on the current state of the network, including availability, network load, network performance, any combination thereof, or the like. In some examples, CSH home 220 may be associated with a particular geographic region (e.g., state, area, coordinates, boundary, range, landscape, etc.). Thus, the one or more operators associated with CSH home 220 may also be within the particular geographic region. More than one CSH home 220 instances may be located over a large area, to maintain consistent coverage over the area.

To enroll in CSH home 220 and participate in the operator marketplace, an operator may enroll in the operator marketplace functionality. In some examples, this would include a secure connection between CSH home 220 and the operator. It may also include a legal agreement between an affiliated sponsor/manager of CSH home 220 and the operator. Once, the operator is registered with CSH home 220, then the operator may begin participating in the operator marketplace.

In some examples, CSH home 220 may transmit data pertaining to all of the operators associated with the operator marketplace. The data may include requested resources, pricing/tariffs, available resources, volume, sustainable data centers, network paths etc. The data may be advertised within the network and/or to associated operators. For example, CSH home 220 may advertise the available resources and associated prices of Operator A 208, Operator B 210, and operator C 212 to the network, such that the operators (Operator A 208, Operator B 210, and operator C 212) receive the availability of the other operators (e.g., operator C 212 knows the resources available from Operator A 208 and Operator B 210 via the advertisement from CSH home 220).

The CSH functionality of CSH A 214, CSH B 216, and/or CSH C 218 may be exposed via corresponding Network Exposure Functions (NEF). An NEF may be a system or component that controls the exposure of network services (e.g., CSH systems) and data to external entities (e.g., CSH home 220), managing access and security. It is typically used to ensure that only authorized users or systems can interact with specific network resources, thereby reducing the risk of unauthorized access or data breaches. For example, CSH A 214 may be exposed via NEF A 222, CSH B 216 may be exposed via NEF B 224, and CSH C 218 may be exposed via NEF C 226.

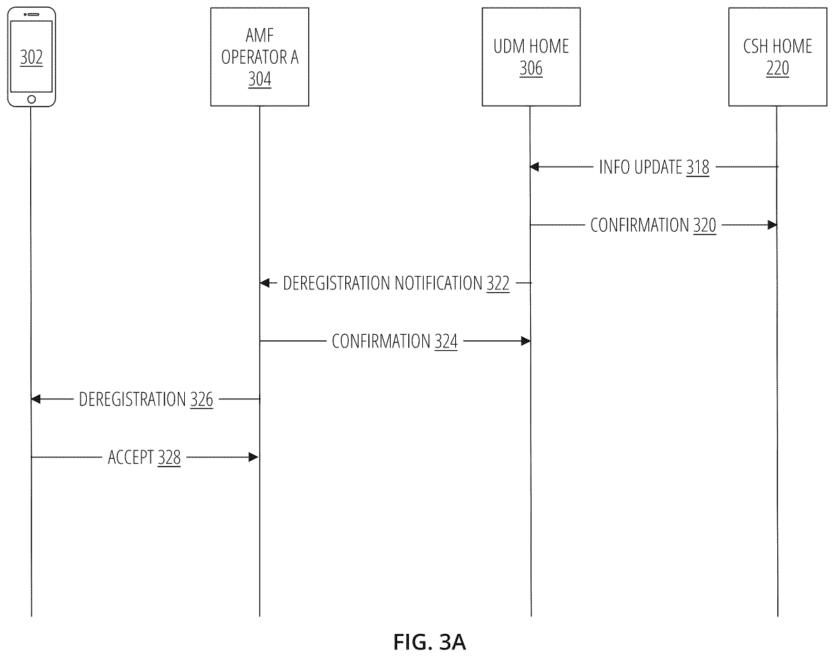

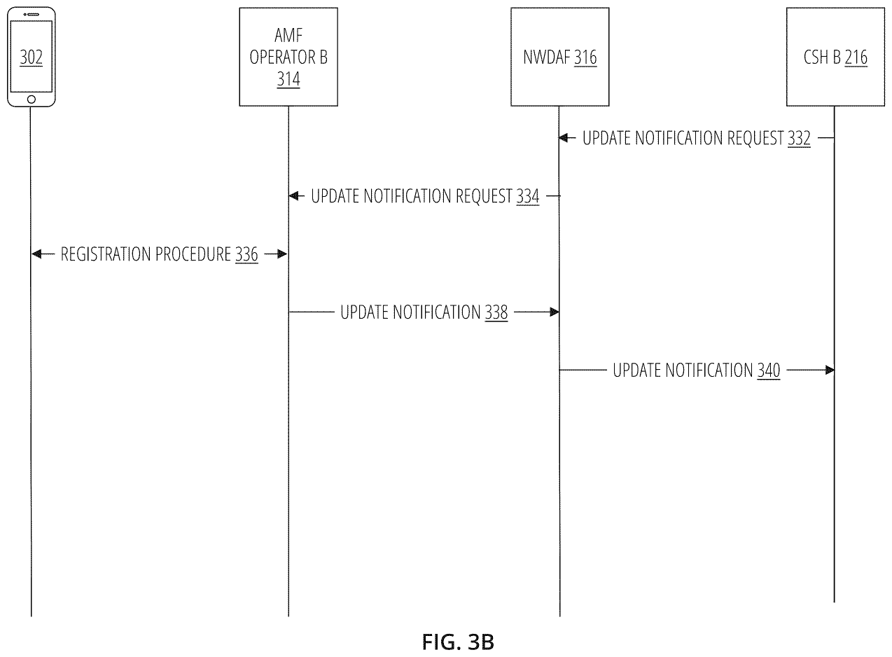

FIG. 3A illustrates an example process for deregistering a user device 302 from an operator according to some aspects of the present technology. In this example, a user device is roaming from Operator A (e.g., Operator A 208 as described in FIG. 2) to Operator B (e.g., Operator B as described in FIG. 2). Operator A and B may have established a roaming agreement via CSH home 220. Before switching to coverage by Operator B, user device 302 may be deregistered from Operator A. The deregistration process may include operations from a Unified Data Management (UDM) system and/or an Access and Mobility Management Function (AMF). UDM (e.g., UDM home 306) may be responsible for managing and storing subscriber data, such as user profiles, authentication credentials, and session management, ensuring that the network services are personalized and securely accessed by users. AMF (e.g., AMF operator A 304) may handle signaling and controlling functions related to user access, mobility, and session management within the network, ensuring seamless connectivity and handover as users move between different network areas (e.g., from Operator A to Operator B).

Transmission of information update 318 may be received by UDM home 306 from CSH home 220. The “information update” transmission may include data pertaining to user device 302 (e.g., identifying information regarding the subscriber that is being moved to a new operator) and/or the new operator associated with user device 302 (e.g., Operator B). Once this information is received by UDM home 306, UDM home 306 sends transmission of confirmation 320 that indicates that UDM home 306 has received transmission of information update 318. UDM home 306 may forward the data included in transmission of information update 318 to AMF operator A 304 in transmission of deregistration notification 322, which may also notify AMF operator A 304 of the deregistration of user device 302. AMF operator A 304 may confirm receipt of the deregistration notification with transmission of confirmation 324.

AMF operator A 304 may send transmission of deregistration 326 to user device 302. Transmission of deregistration 326 may include a deregistration command and/or request associated with user device 302. The deregistration request may include an information element (IE) referenced as CSH priority Public Land Mobile Network (PLMN), which indicates the new operator that may service user device 302 (e.g., Operator B). User device 302 may internally mark the current operator, Operator A, as forbidden. User device 302 may initiate a new registration to Operator B, as described in FIG. 3B. User device 302 may transmit an acceptance (transmission of acceptance 328) of the deregistration.

FIG. 3B illustrates an example process for registering the user device with a roaming operator according to some aspects of the present technology. User device 302, in addition to deregistering from Operator A, may register with Operator B. An example embodiment of the registration process may be described by FIG. 3B. CSH B 216, after reaching a roaming agreement via CSH home 220, may send transmission of update notification request 332 to Network Data Analytics Function (NWDAF) 416 associated with Operator B. NWDAF 316 may provide data analytic services to optimize network performance, enhance service quality, and support decision-making processes by analyzing network data in real-time or near real-time. Transmission of update notification request 332 may include a request to monitor a roaming registration associated with user device 302. In some examples, NWDAF 316 may monitor user device 302 via AMF operator B 314. This may include usage, duration, cost, location, volume, any combination thereof, or the like. Transmission of update notification request 332 may also include a request for CSH B 216 to be notified when user device 302 is registered with Operator B.

NWDAF 316 may forward the request to monitor the roaming registration and/or user device 302 to AMF operator B 314 via transmission of update notification request 334. AMF operator B 314 may initiate a registration procedure via transmission of registration procedure 336. The registration procedure may register user device 302 with Operator B. Once registered, transmission of update notification 338 and transmission of update notification 340 may notify NWDAF 316 and CSH B 216, respectively. Once user device 302 is registered with Operator B, CSH B 216 may initiate a timer associated with a time period determined by the roaming agreement with Operator A. In some examples, the timer may be a time period, but in some examples, it may reference a region that user device 302 is permitted to roam within an area serviced by Operator B, a usage limit, a speed limit, any combination thereof, or the like. While user device 302 is associated and/or registered with Operator B, AMF operator B 314 and/or NWDAF 316 may monitor and report data regarding user device 302 to CSH B 216. In some examples, the data may be transmitted to CSH home (as described in FIG. 2). Once the timer expires and/or a threshold has been met, Operator B, via CSH B 216, may request user device 302 to deregister and re-register with Operator A. In some examples, CSH home 220 (as described in FIG. 2), may initiate the process to move user device 302 back to Operator A.

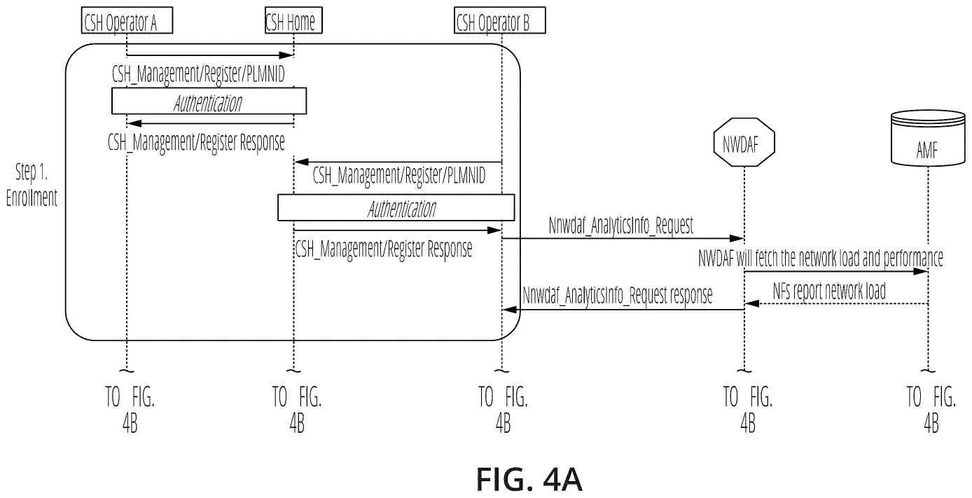

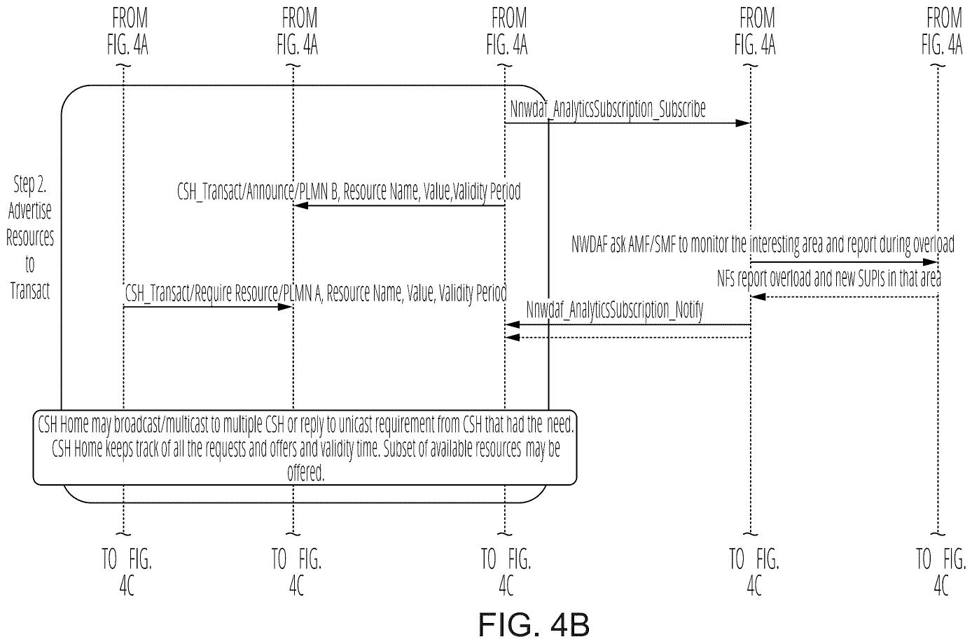

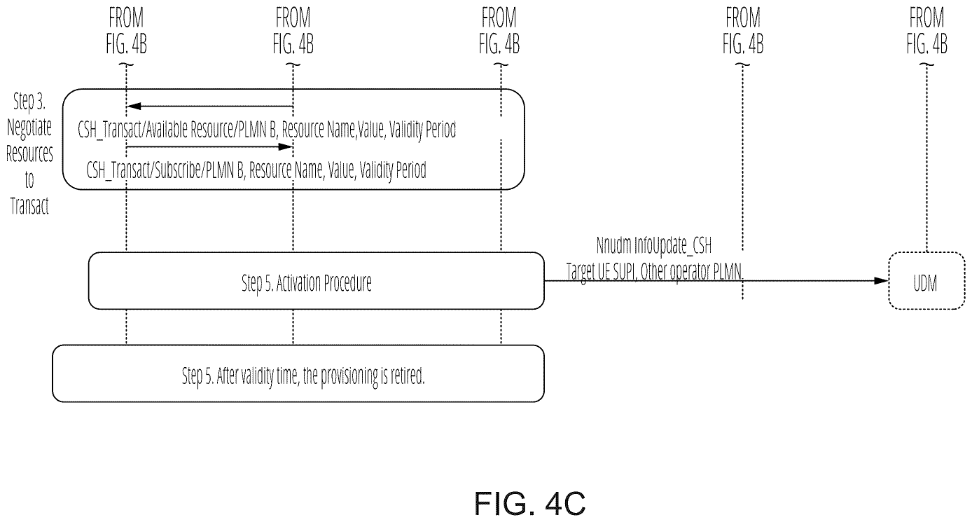

FIG. 4A-FIG. 4C illustrate an example process for facilitating an operator marketplace between one or more operators according to some aspects of the present technology. FIG. 4A-FIG. 4C describe a process for facilitating a roaming agreement between two operators (Operator A and Operator B) using an operator marketplace (CSH Home). In the scenario described in FIG. 4A-FIG. 4C, Operator A requires resources from Operator B. The process may include a CSH instance associated with Operator A (e.g., CSH A 214 and Operator A 208 as described in FIG. 2), CSH home (e.g., CSH home 220 as described in FIG. 2), a CSH instance associated with Operator B (e.g., CSH B 216 and Operator B as described in FIG. 2), an NWDAF associated with Operator B (e.g., NWDAF 316 as described in FIG. 3B), and an AMF associated with Operator B (e.g., AMF operator B 314 as described in FIG. 3B). The components described and pictured in FIG. 4A-FIG. 4C should not be construed as limiting, and are a mere representation of an example embodiment described herein. Additional components not pictured here may be used to implement some aspects of the present technology. For example, Operator A may also be associated with a respective NWDAF instance and AMF operator.

In order to generate a roaming agreement, one or more involved operators may be registered with CSH Home. For example, Operator A and Operator B may register with CSH home. CSH Operator A may transmit a request to register an associated Public Land Mobile Network Identifier (PLMN ID) with CSH home. The request may be authenticated by CSH home (e.g., IPsec, SSH keys, OAuth 2.0, API keys, etc.). In some examples, CSH home and CSH Operator A may enter into a legal agreement for operator. The legal agreement may be signed by one or more administrators associated with CSH home and CSH Operator A. A signed legal agreement and authentication may both be necessary in order for Operator A to be included in CSH home. Once the authentication and/or the legal agreement parameters are met, CSH home may transmit a message to CSH Operator A confirming registration in CSH home. In some examples, the process may be repeated for Operator B. In some examples, the registration of operators may occur concurrently or at different times (e.g., Operator A was registered before Operator B).

Once Operator B is registered with CSH home, CSH Operator B may transmit a request to NWDAF to begin gathering analytics associated with Operator B. This may include network load, bandwidth, speed, available resources, network paths, any combination thereof, or the like. In some examples, NWDAF may be used for analytics, machine-learning, and patterning functionality. NWDAF may transmit a request to AMF to begin monitoring one or more aspects of the network performance according to the request from CSH Operator B. AMF may begin transmitting analytics to NWDAF, and the NWDAF may confirm that analytics are being tracked by AMF and transmit a response accordingly.

Moving to FIG. 4B, CSH Operator B may transmit a request for NWDAF and/or AMF to monitor areas that may require additional resources. NWDAF may forward the request to AMF, which may in turn report overloads in the network that may require additional resources from other operators. For example, AMF may report new user devices that have connected to the network in a particular area, which may include users that are roaming from other operators. NWDAF may alert CSH Operator B if there is an overload on the network that meets and/or exceeds a particular threshold for bandwidth, speed, latency, any combination thereof, or the like. In some examples, CSH Operator B may utilize these notifications to advertise needed resources to CSH Home. In this particular example, the necessary resources do not rise to a level of requiring additional resources from other operators.

In some examples, CSH Operator B may also advertise what resources it has available to other operators associated with CSH Home. The advertisement may include an operator identifier, resources that are available, time frames, cost, tariffs, any combination thereof, or the like. CSH Operator A may advertise what resources it requires to CSH Home (e.g., needed resources, time frames, budget, etc.). Using the advertisements from CSH Operator A and CSH Operator B, CSH Home may cross-reference the two advertisements and determine that the two advertisements are compatible (e.g., CSH Operator B meets the terms outlined by CSH Operator A). In some examples, CSH Home may track advertisements and requests associated with a large amount of operators and may facilitate a large amount of transactions between operators. In some examples, CSH Operator A may not require all of the resources offered by CSH Operator B. Thus, CSH Operator A may transact for a subset of the resources offered by CSH Operator B. In a similar manner, CSH Operator B may not meet all the needs of CSH Operator A. Thus, CSH Operator A may transact with more than one operator (e.g., an Operator C, Operator D, etc.) such that a summation of the resources offered by more than one Operator meet the needs of CSH Operator A.

Moving to FIG. 4C, CSH Home may facilitate the transaction between CSH Operator B and CSH Operator A. This may include negotiating resources, negotiating tariffs, and/or pricing between the operators, determining a validity period (e.g., time frame for the agreement), exchanging legal documents, any combination thereof, or the like. In some examples, this negotiation may be performed autonomously based on policies associated with respective operators. In some other examples, an administrator associated with respective operators may approve and/or supervise the negotiation. Once the transaction is confirmed by both operators (e.g., CSH Operator A and CSH Operator B), the activation procedure (as outlined in FIG. 3B) and deactivation procedure (as outlined in FIG. 3A) may be initiated by CSH instances and/or CSH Home. After the validity time expires, the associated user devices may return to original operators. In some examples, the validity time may be a duration of time (e.g., 24 hours, 30 minutes, one week, etc.), an amount of usage, a number of users (e.g., Operator B will support 100 additional devices), any combination thereof, or the like.

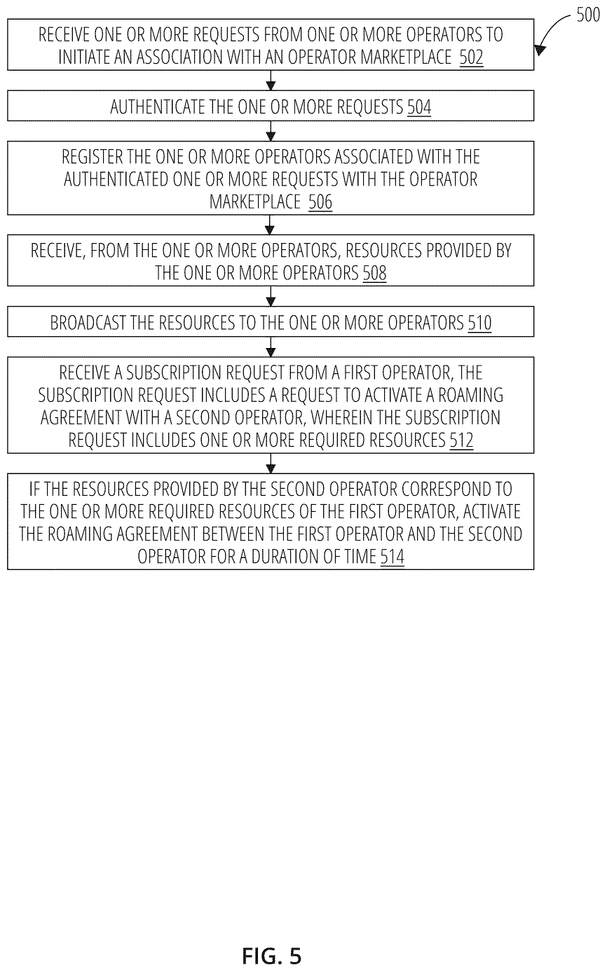

FIG. 5 illustrates an example flowchart for facilitating an operator marketplace between one or more operators according to some aspects of the present technology. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to some examples, the method includes receiving one or more requests from one or more operators to initiate an association with an operator marketplace at block 502. For example, CSH home 220 (as described in FIG. 2) may receive one or more requests from CSH A 214, CSH B 216, and/or CSH C 218 (as described in FIG. 2) to initiate an association with the operator marketplace. The one or more operators are associated with an instance of a cellular system hub (CSH) and the respective CSH for the one or more operators facilitates the activation and deactivation of service for associated user devices.

According to some examples, the method includes authenticating the one or more requests at block 504. For example, CSH home 220 (as described in FIG. 2) may authenticate the one or more requests from CSH A 214, CSH B 216, and/or CSH C 218 (as described in FIG. 2).

According to some examples, the method includes registering the one or more operators associated with the authenticated one or more requests with the operator marketplace at block 506. For example, CSH home 220 (as described in FIG. 2) may register CSH A 214, CSH B 216, and/or CSH C 218 (as described in FIG. 2) associated with the authenticated one or more requests with the operator marketplace. Once the one or more operators are registered, the one or more operators may begin advertising available and/or needed resources to the operator marketplace.

According to some examples, the method includes receiving, from the one or more operators, resources provided by the one or more operators at block 508. For example, CSH home 220 (as described in FIG. 2) may receive resources provided by CSH A 214, CSH B 216, and/or CSH C 218 (as described in FIG. 2). In some examples, instances of CSH at the one or more operators may monitor respective operators with a network data analytics function (NWDAF). For example, CSH A 214 may monitor Operator A using a NWDAF. In some examples, the NWDAF may utilize an AMF to monitor analytics of the network. The NWDAF determines, using analytics associated with the one or more operators, the one or more resources available from the one or more operators.

According to some examples, the method includes broadcasting the resources to the one or more operators at block 510. For example, CSH home 220 (as described in FIG. 2) may broadcast the resources to the one or more operators associated with the operator marketplace, such as CSH A 214, CSH B 216, and/or CSH C 218 (as described in FIG. 2). In some examples, the operator marketplace may also broadcast required resources associated with the one or more operators. For example, if Operator A requires some resources, then the operator marketplace may also broadcast Operator A's willingness to enter into a roaming agreement for the required resources.

According to some examples, the method includes receiving a subscription request from a first operator, the subscription request includes a request to activate a roaming agreement with a second operator, wherein the subscription request includes one or more required resources at block 512. For example, CSH home 220 (as described in FIG. 2) may receive the subscription request from Operator A, the subscription request includes a request to activate the roaming agreement with Operator B, wherein the subscription request includes one or more required resources.

According to some examples, the method includes if the resources provided by the second operator correspond to the one or more required resources of the first operator, activate the roaming agreement between the first operator and the second operator for a duration of time at block 514. For example, CSH home 220 (as described in FIG. 2) may activate a roaming agreement between Operator A and Operator B if the resources provided by Operator B correspond to the required resources of Operator A. The roaming agreement may include a duration of time, bandwidth limits, a number of users, speed, or any other parameters pertaining to the terms of the roaming agreement.

When the roaming agreement is activated, a CSH associated with the first operator transmits a request to de-register a first user device from a communication network associated with the first operator. In some examples, the operator marketplace may transmit a message to a unified data management (UDM) of the first network that includes at least the roaming agreement, an identification of the user device and the second operator. When the roaming agreement is activated, a CSH associated with the second operator transmits a request to register a first user device from a communication network associated with the second operator. When the duration of time ends, the roaming agreement expires and associated user devices serviced by the second operator by the roaming agreement resume service from the first operator.

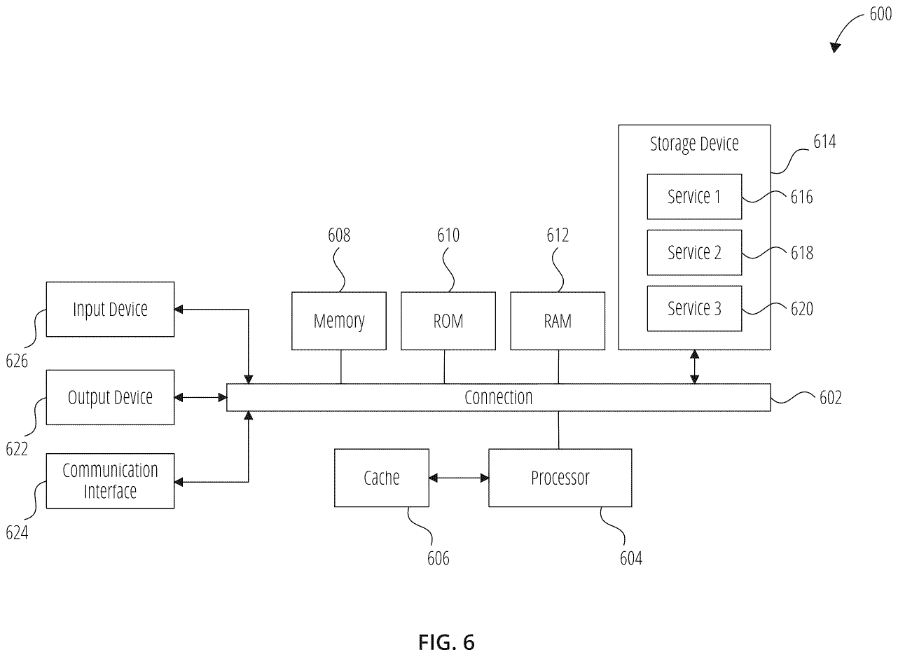

FIG. 6 shows an example of computing system 600, which can be for example any computing device making up the operator marketplace or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) 604 and connection 602 that couples various system components including system memory 608, such as read-only memory (ROM) 610 and random access memory (RAM) 612 to processor 604. Computing system 600 can include a cache of high-speed memory 606 connected directly with, in close proximity to, or integrated as part of processor 604.

Processor 604 can include any general purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method for a marketplace for roaming agreements, comprising:
receiving, from one or more operators associated with an operator marketplace, a description of resources provided by the one or more operators;
broadcasting the description of resources to the one or more operators;
receiving a subscription request from a first operator, the subscription request includes a request to activate a roaming agreement with a second operator, wherein the subscription request includes one or more required resources; and
when the resources provided by the second operator correspond to the one or more required resources of the first operator, activating the roaming agreement between the first operator and the second operator for a duration of time.

2. The computer-implemented method of claim 1, further comprising:
receiving one or more requests from the one or more operators to initiate an association with the operator marketplace;
authenticating the one or more requests; and
registering the one or more operators associated with the one or more requests with the operator marketplace.

3. The computer-implemented method of claim 1, wherein when the duration of time ends, the roaming agreement expires and associated user devices, serviced by the second operator by the roaming agreement, resume service from the first operator.

4. The computer-implemented method of claim 1, wherein the one or more operators are associated with an instance of a cellular system hub (CSH) and the respective CSH for the one or more operators facilitates the activation and deactivation of service for associated user devices.

5. The computer-implemented method of claim 4, wherein the respective CSH for the one or more operators monitors the one or more operators with a network data analytics function (NWDAF).

6. The computer-implemented method of claim 5, wherein the NWDAF determines, using analytics associated with the one or more operators, the resources available from the one or more operators.

7. The computer-implemented method of claim 1, wherein when the roaming agreement is activated, a CSH associated with the first operator transmits a request to de-register a first user device from a communication network associated with the first operator.

8. The computer-implemented method of claim 1, wherein when the roaming agreement is activated, a CSH associated with the second operator transmits a request to register a first user device from a communication network associated with the second operator.

9. The computer-implemented method of claim 1, further comprising:
transmitting a message to a unified data management (UDM) of the first operator that includes at least the roaming agreement, an identification of a user device, and the second operator.

10. A system comprising:
one or more processors; and
a memory storing instructions that, when executed by the one or more processors, configure the system to:
receive, from one or more operators associated with an operator marketplace, a description of resources provided by the one or more operators;
broadcast the description of resources to the one or more operators;
receive a subscription request from a first operator, the subscription request includes a request to activate a roaming agreement with a second operator, wherein the subscription request includes one or more required resources; and
when the resources provided by the second operator correspond to the one or more required resources of the first operator, activate the roaming agreement between the first operator and the second operator for a duration of time.

11. The system of claim 10, wherein the instructions further configure the system to:
receive one or more requests from the one or more operators to initiate an association with the operator marketplace;
authenticate the one or more requests; and
register the one or more operators associated with the one or more requests with the operator marketplace.

12. The system of claim 10, wherein when the duration of time ends, the roaming agreement expires and associated user devices, serviced by the second operator by the roaming agreement, resume service from the first operator.

13. The system of claim 10, wherein the one or more operators are associated with an instance of a cellular system hub (CSH) and the respective CSH for the one or more operators facilitates the activation and deactivation of service for associated user devices.

14. The system of claim 13, wherein the respective CSH for the one or more operators monitors the one or more operators with a network data analytics function (NWDAF).

15. The system of claim 14, wherein the NWDAF determines, using analytics associated with the one or more operators, the resources available from the one or more operators.

16. The system of claim 10, wherein when the roaming agreement is activated, a CSH associated with the first operator transmits a request to de-register a first user device from a communication network associated with the first operator.

17. The system of claim 10, wherein when the roaming agreement is activated, a CSH associated with the second operator transmits a request to register a first user device from a communication network associated with the second operator.

18. The system of claim 10, wherein the instructions further configure the system to:
transmit a message to a unified data management (UDM) of the first operator that includes at least the roaming agreement, an identification of a user device, and the second operator.

19. A non-transitory computer-readable storage medium, the non-transitory computer-readable storage medium including instructions that when executed by a computer, cause the computer to:
receive, from one or more operators associated with an operator marketplace, a description of resources provided by the one or more operators;
broadcast the description of resources to the one or more operators;
receive a subscription request from a first operator, the subscription request includes a request to activate a roaming agreement with a second operator, wherein the subscription request includes one or more required resources; and
when the resources provided by the second operator correspond to the one or more required resources of the first operator, activate the roaming agreement between the first operator and the second operator for a duration of time.

20. The non-transitory computer-readable storage medium of claim 19, wherein the instructions further configure the computer to:
receive one or more requests from the one or more operators to initiate an association with the operator marketplace;
authenticate the one or more requests; and
register the one or more operators associated with the one or more requests with the operator marketplace.
